(19) United States
(12) Patent Application Publication
(10) Pub. No.: US 2018/0097261 A1
(43) Pub. Date: Apr. 5, 2018

(54) METHOD OF ELIMINATING MICRO SHORT CIRCUIT, METHOD FOR DECREASING DENDRITE, AND CHARGE CONTROL DEVICE FOR LITHIUM-ION BATTERY

(71) Applicant: HONDA MOTOR CO., LTD., Tokyo (JP)

(72) Inventors: Junji KUWABARA, Wako (JP); Masaji SAWA, Wako (JP); Kenji SATO, Wako (JP)

(73) Assignee: HONDA MOTOR CO., LTD., Tokyo (JP)

(21) Appl. No.: 15/696,179

(22) Filed: Sep. 6, 2017

(30) Foreign Application Priority Data
Oct. 4, 2016 (JP) 2016-196734

(51) Int. Cl. H01M 10/44; H01M 10/0525; H01M 10/46

(52) U.S. Cl. CPC H01M 10/44; H01M 10/46; H01M 10/0525

(57) ABSTRACT

A method for decreasing a dendrite generated in a lithium-ion battery includes: charging the lithium-ion battery so that the dendrite is generated due to precipitation of a foreign metal other than a cathode active material mixture and an anode active material mixture in an electrolyte solution filling the lithium-ion battery; and charging the lithium-ion battery to maintain an SOC of the lithium-ion battery at a predetermined value for more than a predetermined time to decrease the dendrite.

### CROSS-REFERENCE TO RELATED APPLICATIONS

The present application claims priority under 35 U. S. C. § 119 to Japanese Patent Application No. 2016-196734, filed Oct. 4, 2016. The contents of this application are incorporated herein by reference in their entirety.

### BACKGROUND OF THE INVENTION

### Field of the Invention

The present invention relates to a method of eliminating a micro short circuit, to a method for decreasing a dendrite, and to a charge control device for a lithium-ion battery.

### Discussion of the Background

Methods (e.g., Japanese Patent Application Publication No. 2014-022217) of eliminating a micro short circuit in a lithium-ion battery have been known, the micro short circuit caused by dendrites generated from dissolution and precipitation of metal contaminants included in a manufacturing process. In the prior patent, charging and discharging is repeated with a higher current than a predetermined charging current. The micro short circuit caused by dendrites due to precipitated metal contaminants is eliminated in this manner.

### SUMMARY

According to one aspect of the present invention, a method of eliminating a micro short circuit caused by a dendrite (e.g., later-mentioned dendrite D), which is generated from dissolution and precipitation of a foreign metal other than a cathode active material mixture or an anode active material mixture between a cathode (e.g., later-mentioned cathode 401) and an anode (e.g., later-mentioned anode 402), of a lithium-ion battery configured of the cathode, the anode, a separator (e.g., later-mentioned separator 403) interposed therebetween, and an electrolyte solution filling the lithium-ion battery, includes an SOC maintaining step of charging the lithium-ion battery continuously to maintain an SOC of the lithium-ion battery at a predetermined value for not shorter than a predetermined time.

According to another aspect of the present invention, a method for decreasing a dendrite generated in a lithium-ion battery includes: charging the lithium-ion battery so that the dendrite is generated due to precipitation of a foreign metal other than a cathode active material mixture and an anode active material mixture in an electrolyte solution filling the lithium-ion battery; and charging the lithium-ion battery to maintain an SOC of the lithium-ion battery at a predetermined value for more than a predetermined time to decrease the dendrite.

According to further aspect of the present invention, a charge control device for a lithium-ion battery, includes: a power drive circuit to charge the lithium-ion battery; a processor. The processor is configured to control the power drive circuit to: charge the lithium-ion battery so that a dendrite is generated due to precipitation of a foreign metal other than a cathode active material mixture and an anode active material mixture in an electrolyte solution filling the lithium-ion battery; and charge the lithium-ion battery to maintain an SOC of the lithium-ion battery at a predetermined value for more than a predetermined time to decrease the dendrite.

According to further aspect of the present invention, a charge control device for a lithium-ion battery, includes: a power drive circuit for charging the lithium-ion battery; control means for controlling the power drive circuit to: charge the lithium-ion battery so that a dendrite is generated due to precipitation of a foreign metal other than a cathode active material mixture and an anode active material mixture in an electrolyte solution filling the lithium-ion battery; and charge the lithium-ion battery to maintain an SOC of the lithium-ion battery at a predetermined value for more than a predetermined time to decrease the dendrite.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a schematic block diagram of a vehicle in which a vehicle charge control method of a first embodiment of the present invention is performed.

FIG. 2 is an enlarged view of a low SOC area 404, which is generated by a micro short circuit due to contact of a precipitated dendrite in a lithium-ion battery of the vehicle in which the vehicle charge control method of the first embodiment of the present invention is performed.

FIG. 3 is an enlarged view of a state where the low SOC area 404, which is generated by the micro short circuit due to contact of the precipitated dendrite in the lithium-ion battery of the vehicle in which the vehicle charge control method of the first embodiment of the present invention is performed, starts to shrink and changes into a small low SOC area 405.

FIG. 4 is an enlarged view of a state where the precipitated dendrite in the lithium-ion battery of the vehicle in which the vehicle charge control method of the first embodiment of the present invention is performed has melted, and the micro short circuit is about to be eliminated.

FIG. 5 is a flowchart illustrating the vehicle charge control method of the first embodiment of the present invention.

FIG. 6 is a graph illustrating an example of a micro short circuit amount-judging map at low temperature of the lithium-ion battery, used in the vehicle charge control method of the first embodiment of the present invention.

FIG. 7 is a graph illustrating a micro short circuit amount-judging map at high temperature of the lithium-ion battery, used in the vehicle charge control method of the first embodiment of the present invention.

FIG. 8 is a graph illustrating an example of a micro short circuit eliminating mode map for a small micro short circuit, used in the vehicle charge control method of the first embodiment of the present invention.

FIG. 9 is a graph illustrating an example of a micro short circuit eliminating mode map for a large micro short circuit, used in the vehicle charge control method of the first embodiment of the present invention.

FIG. 10 is a graph illustrating variation in a voltage value and a current value over time, in CC charging and CV charging performed in the vehicle charge control method of the first embodiment of the present invention.

FIG. 11 is an enlarged graph of a charge start time in the graph of FIG. 10.

FIG. 12 is a schematic diagram of an experiment device for creating a micro short circuit amount-judging map at high temperature of the lithium-ion battery, and a micro short circuit eliminating mode map, used in the vehicle charge control method of the first embodiment of the present invention.

FIG. 13 is a graph illustrating variation in the voltage value over time, when performing CC charging and CV charging to eliminate a micro short circuit by using different voltages for CV charging.

FIG. 14 is a graph illustrating variation in the required CV charge current over time, when performing CC charging and CV charging to eliminate a micro short circuit by using different voltages for CV charging.

FIG. 15 is a graph illustrating variation in the cell voltage value of lithium-ion battery over time, after performing CC charging and CV charging to eliminate a micro short circuit by using different voltages for CV charging.

FIG. 16 is a graph illustrating the relationship between the drop speed of the cell voltage value of lithium-ion battery over time after performing CC charging and CV charging to eliminate a micro short circuit, and the volume of a contaminant forming a dendrite precipitated in the cell.

FIG. 17 is a graph illustrating variation in the required CV charge current over time, when performing CV charging to eliminate a micro short circuit by using different voltages for the CV charging.

FIG. 18 is a graph illustrating the relationship between the voltage value of CV charging for eliminating a micro short circuit, and the inverse of the required time of eliminating the micro short circuit.

FIG. 19 is a graph illustrating variation in the charge voltage value over time, when performing CC charging and CV charging to eliminate a micro short circuit in lithium-ion batteries of different temperatures.

FIG. 20 is a graph illustrating variation in the required CV charge current over time, when performing CC charging and CV charging to eliminate a micro short circuit in lithium-ion batteries of different temperatures.

FIG. 21 is a graph illustrating the relationship between the inverse of the temperature of the lithium-ion battery when performing CV charging to eliminate a micro short circuit, and the inverse of the required time of eliminating a micro short circuit.

FIG. 22 is a graph illustrating variation in the cell voltage value of lithium-ion battery overtime, after performing CC charging and CV charging to eliminate a micro short circuit in lithium-ion batteries of different temperatures.

FIG. 23 is a graph illustrating the relationship between the required time of eliminating a micro short circuit and the volume of a contaminant that caused dendrites precipitated in a cell, when performing CV charging at different voltages.

FIG. 24 is a graph illustrating the relationship between the required time of eliminating a micro short circuit and the volume of a contaminant forming dendrites precipitated in a cell, when performing CV charging in lithium-ion batteries of different temperatures.

### DESCRIPTION OF THE EMBODIMENTS

The embodiments will now be described with reference to the accompanying drawings, wherein like reference numerals designate corresponding or identical elements throughout the various drawings.

Hereinafter, a first embodiment of the present invention will be described in detail with reference to the accompanying drawings. Note that in the description of a second embodiment and the following embodiments, configurations and the like common to the first embodiment are assigned the same reference numeral, and descriptions thereof are omitted.

### First Embodiment

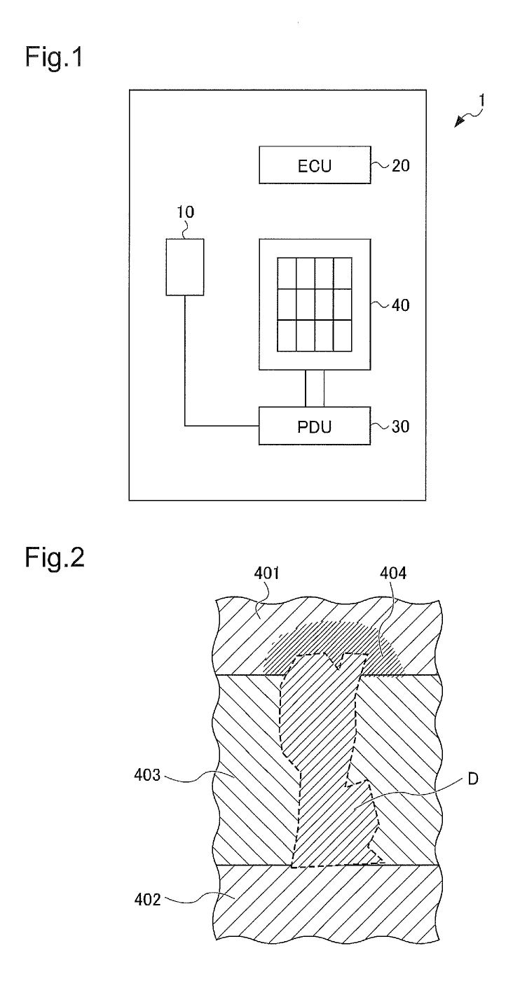

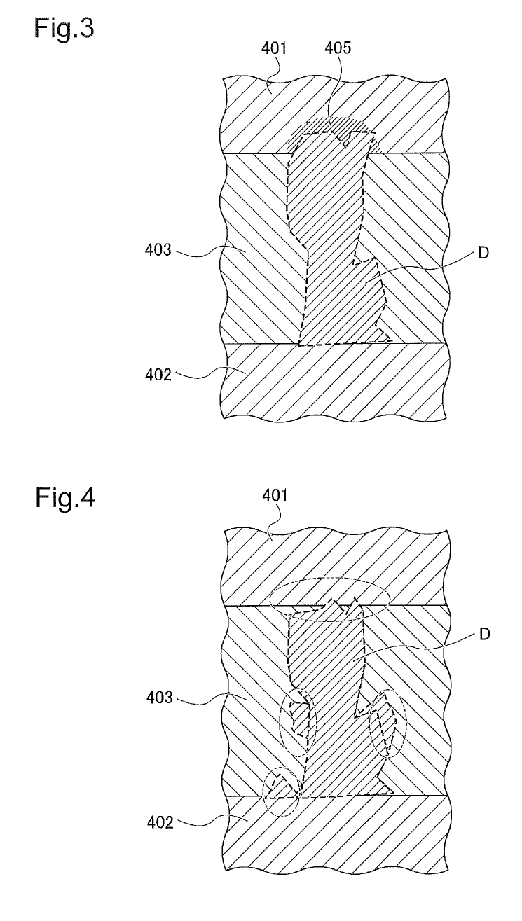

FIG. 1 is a schematic block diagram of a vehicle in which a vehicle charge control method of a first embodiment of the present invention is performed. FIG. 2 is an enlarged view of a low SOC area 404, which is generated by a micro short circuit due to contact of a precipitated dendrite in a lithium-ion battery of the vehicle in which the vehicle charge control method of the first embodiment of the present invention is performed. FIG. 3 is an enlarged view of a state where the low SOC area 404, which is generated by the micro short circuit due to contact of the precipitated dendrite in the lithium-ion battery of the vehicle in which the vehicle charge control method of the first embodiment of the present invention is performed, starts to shrink and changes into a small low SOC area 405. FIG. 4 is an enlarged view of a state where the precipitated dendrite in the lithium-ion battery of the vehicle in which the vehicle charge control method of the first embodiment of the present invention is performed has melted, and the micro short circuit is about to be eliminated.

As shown in FIG. 1, the present invention may be applied to a vehicle 1 in this embodiment. The vehicle 1 is an electric vehicle (EV) that uses an electric motor 10 configured of a motor as a power force, to drive unillustrated right and left front wheels. The vehicle 1 includes the electric motor 10, an electronic control unit (hereinafter referred to as “ECU 20”) as a controller that controls the electric motor 10, a PDU 30 (power drive unit), and a battery 40. The electric motor 10 drives the unillustrated front wheels. ECU 20 corresponds to a charge control device having a processor.

The electric motor 10 is a three-phase motor that has a U phase, a V phase, and a W phase, for example, and generates torque for driving the vehicle 1 with electric power stored in the battery 40. The electric motor 10 is connected to the battery 40, through the PDU 30 that includes an inverter. A driver Presses an accelerator pedal and a brake pedal to input control signals from the ECU 20 to the PDU 30, to thereby control power supply from the battery 40 to the electric motor 10 and energy regeneration from the electric motor 10 to the battery 40. Control signals from the ECU 20 prompt execution of a method of eliminating a micro short circuit, a lithium-ion battery management method, and a charge control method of the vehicle 1.

An unillustrated friction brake is provided on each of the unillustrated front wheels and rear wheels. The friction brake is configured of a hydraulic disc brake, for example. When a driver presses a brake pedal, the pressing force is increased and transmitted to a brake pad through a hydraulic cylinder, for example. Frictional force is generated between the brake disc and brake pad attached to each drive wheel, and puts a brake on each drive wheel.

The battery 40 is configured of a lithium-ion battery. The battery 40 has multiple cells each configured of a cathode, an anode, and a separator arranged therebetween, and filled with an electrolyte solution. The multiple cells are stacked in the battery 40. A voltage sensor is electrically connected to each cell, and the ECU 20 inputs a voltage value of each cell.

Sometimes, a contaminant (e.g., copper and iron) is included in a manufacturing process of a lithium-ion battery. When a contaminant (e.g., copper and iron) is included, the contaminant melts, precipitates, and generates a dendrite D in the cathode of the cell of the lithium-ion battery, as illustrated in FIG. 2. As illustrated in FIG. 2, when the dendrite D is generated such that it straddles a cathode 401 and an anode 402 having a separator 403 interposed therebetween, a micro short circuit is generated.

Next, a description will be given of how the ECU 20 performs control to execute a vehicle charge control method in which the lithium-ion battery management method is applied to the vehicle 1, and a method of eliminating a micro short circuit executed in the vehicle charge control method.

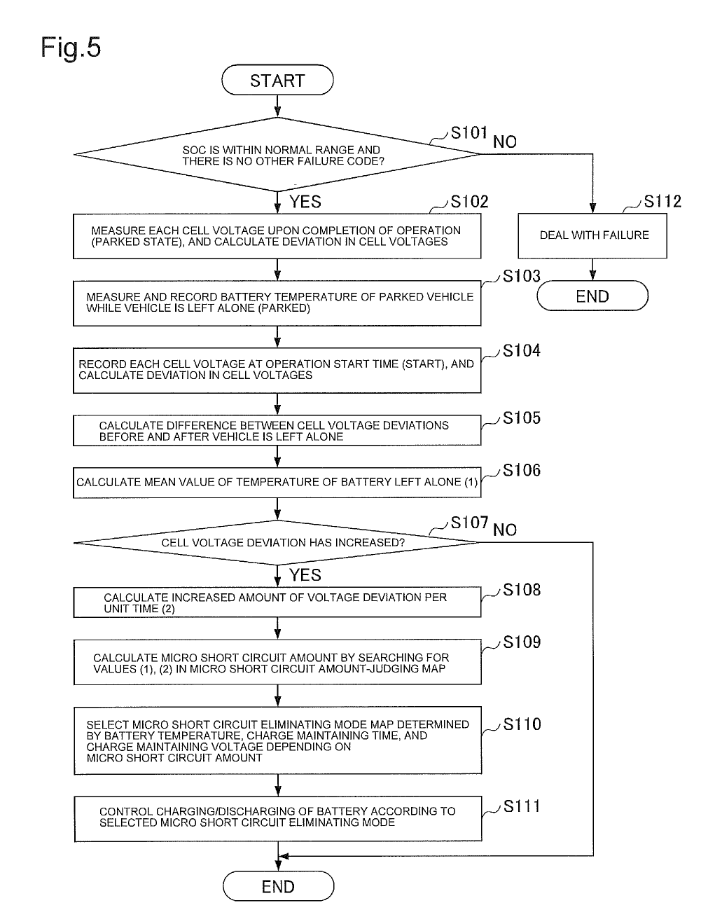

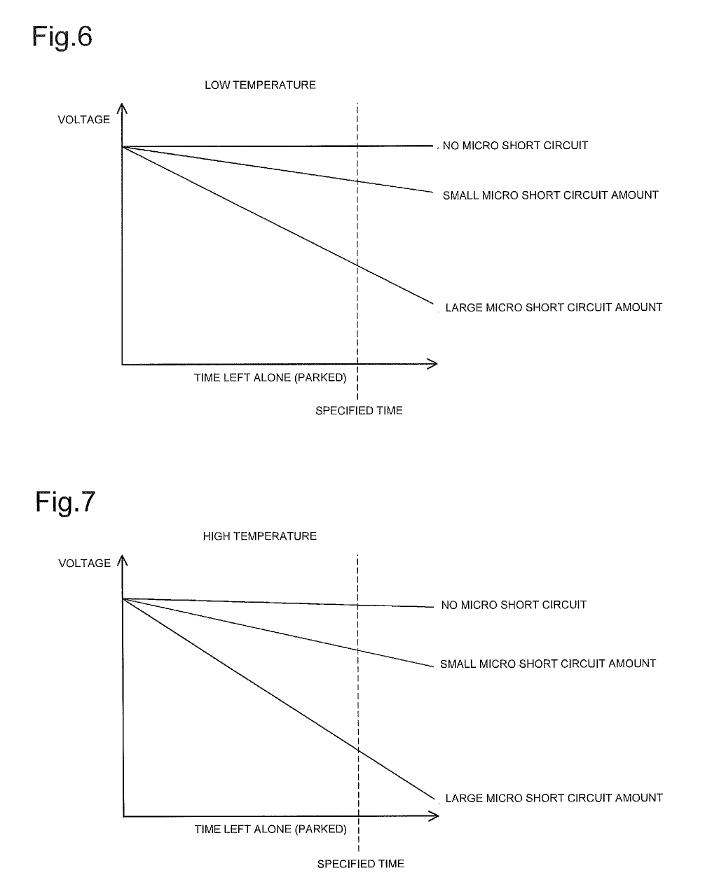

FIG. 5 is a flowchart illustrating the vehicle charge control method of the first embodiment of the present invention. FIG. 6 is a graph illustrating an example of a micro short circuit amount-judging map at low temperature of the lithium-ion battery, used in the vehicle charge control method of the first embodiment of the present invention.

FIG. 7 is a graph illustrating an example of a micro short circuit amount-judging map at high temperature of the lithium-ion battery, used in the vehicle charge control method of the first embodiment of the present invention.

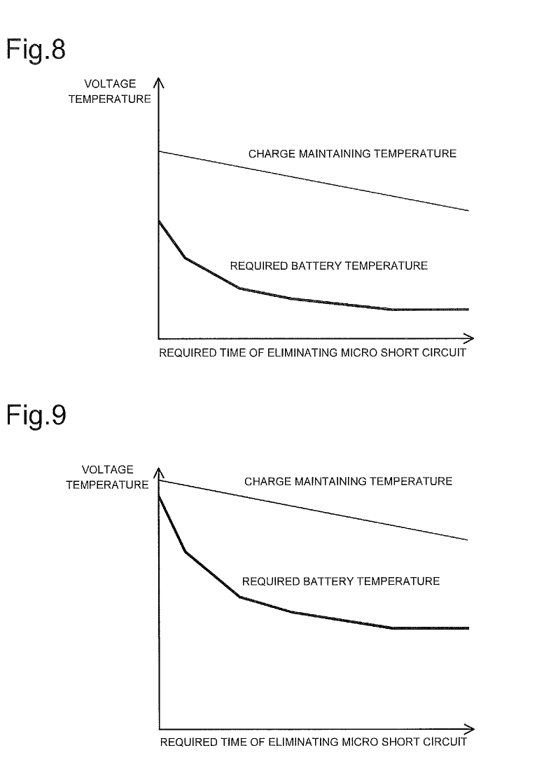

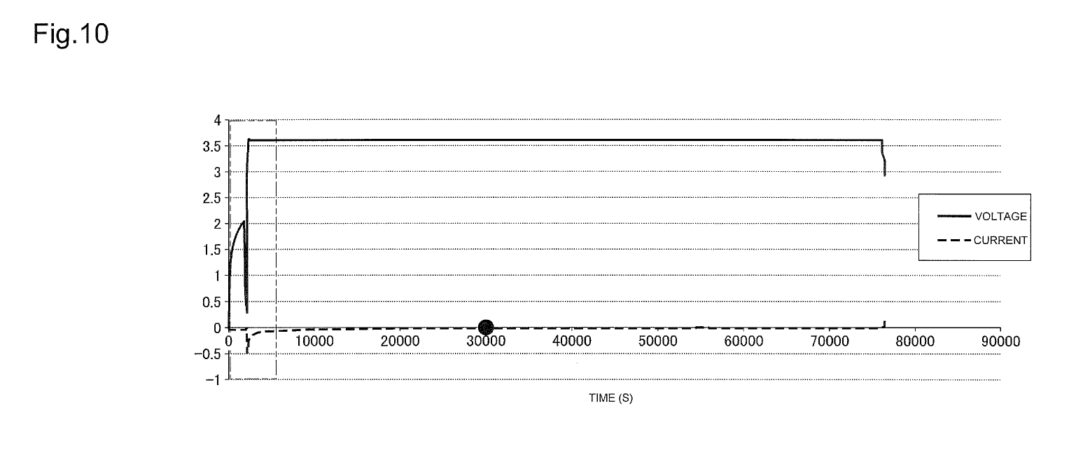

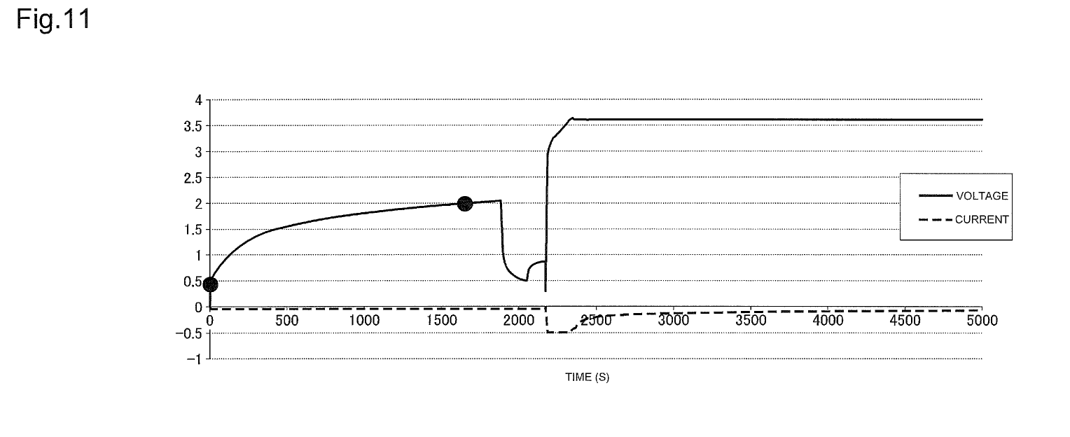

FIG. 8 is a graph illustrating an example of a micro short circuit eliminating mode map for a small micro short circuit, used in the vehicle charge control method of the first embodiment of the present invention. FIG. 9 is a graph illustrating an example of a micro short circuit eliminating mode map for a large micro short circuit, used in the vehicle charge control method of the first embodiment of the present invention. FIG. 10 is a graph illustrating variation in a voltage value and a current value over time, in CC charging and CV charging performed in the vehicle charge control method of the first embodiment of the present invention. FIG. 11 is an enlarged graph of a charge start time in the graph of FIG. 10.

First, in step S101 in FIG. 5, the ECU 20 determines whether the capacity of the lithium-ion battery is within normal range, and whether any other failure code, that is, trouble has occurred in the lithium-ion battery. If the ECU 20 determines that the capacity of the lithium-ion battery is within normal range, and no other failure code, that is, trouble has occurred in the lithium-ion battery (YES), the processing of the ECU 20 proceeds to step S102.

If the ECU 20 determines that the capacity of the lithium-ion battery is not within normal range, and/or another failure code, that is, trouble has occurred in the lithium-ion battery (NO), the processing of the ECU 20 proceeds to step S112, and the failure of the lithium-ion battery is dealt with.

In step S102, the ECU 20 performs a highly charged state-calculation and measurement step of measuring the voltage of each cell in a highly charged state, and calculating deviation in the voltages of the cells. Specifically, the ECU measures the voltage of each cell upon completion of operation of the vehicle 1, that is, at the time of stopping of the vehicle 1 after running, and calculates deviation in the voltages of the cells. More specifically, the ECU calculates whether a voltage drop speed of a specific cell is significantly larger than other cells. Then, the processing of the ECU 20 proceeds to step S103.

In step S103, the ECU 20 measures and records the temperature of the vehicle 1 while the vehicle 1 is left alone, that is, while being parked. The processing of the ECU 20 then proceeds to step S104.

In step S104, the ECU 20 performs a less charged state-calculation and measurement step of measuring the voltage of each cell in a less charged state after the elapse of a predetermined time from the highly charged state-calculation and measurement step (S102), and calculating deviation in the voltages of the cells. Specifically, the ECU measures the voltage of each cell at the time of starting of operation, that is, at the time of starting of the vehicle 1, and calculates the deviation in the voltages of the cells. More specifically, the ECU calculates whether a voltage drop speed of a specific cell is significantly larger than other cells, for example, as in step S102. Then, the processing of the ECU 20 proceeds to step S105.

In step S105, the ECU 20 performs a micro short circuit generation judging step of judging generation of a micro short circuit, by comparing deviations in cell voltages in the highly charged state and in the less charged state. Specifically, the ECU calculates the difference between cell voltage deviations before and after the vehicle is left alone, that is, the difference between cell voltage deviations at the time of stopping after running, and starting of the vehicle 1. The processing of the ECU 20 then proceeds to step S106. In step S106, the ECU 20 calculates a mean value of the temperature of the lithium-ion battery while the vehicle 1 is left alone. Then, the processing of the ECU 20 proceeds to step S107.

In step S107, the ECU 20 determines whether deviation in the cell voltage has increased, that is, whether the difference of deviations calculated in step S105 has become larger than the difference of deviations calculated in the previous step S105. If the ECU 20 determines that the deviation in the cell voltage has increased, the processing of the ECU 20 proceeds to step S108. If the ECU 20 determines that the deviation in the cell voltage has not increased, the processing of the ECU 20 is terminated (END).

In step S108, the ECU 20 calculates the increased amount of cell voltage deviation per unit time, by use of the difference between deviations calculated in step S105. The processing of the ECU 20 then proceeds to step S109. In step S109, the ECU 20 calculates a micro short circuit amount (e.g., none, small, and large) by use of a micro short circuit amount-judging map, using the mean value of the temperature of the lithium-ion battery calculated in step S106, and the increased amount of cell voltage deviation per unit time calculated in step S108.

The micro short circuit amount-judging map used in this embodiment is previously stored in an unillustrated storage medium to which the ECU 20 is connected. As illustrated in FIGS. 6 and 7, for example, the micro short circuit amount-judging map is a graph that is separated into cases of low temperature and high temperature, and illustrates how the voltage lowers with the elapse of parking time for when there is no micro short circuit, when the micro short circuit is small, and when the micro short circuit is large. The processing of the ECU 20 then proceeds to step S110.

In step S110, the ECU 20 selects a micro short circuit eliminating mode map which is determined by the temperature of the lithium-ion battery, the required charge time for eliminating the micro short circuit, the applied charge voltage for eliminating the micro short circuit, based on the micro short circuit amount.

The micro short circuit eliminating mode map used in this embodiment is previously stored in an unillustrated storage medium to which the ECU 20 is connected. As illustrated in FIGS. 8 and 9, for example, the micro short circuit eliminating mode map is a graph that is separated into cases of a large micro short circuit amount and a small micro short circuit amount, and defines values of the charge voltage for eliminating the micro short circuit and the temperature of the lithium-ion battery to be varied by control under the ECU 20.

That is, if the micro short circuit amount is large, the charge voltage is set high and/or the charge time is set long, as illustrated in FIG. 9. If the micro short circuit amount is small, the charge voltage is set low and/or the charge time is set short, as illustrated in FIG. 8. The processing of the ECU 20 then proceeds to step S111.

In step S111, the ECU 20 performs a step of executing a micro short circuit eliminating operation upon generation of a micro short circuit. Specifically, the ECU allows transition to a charging mode for eliminating the micro short circuit, that is, to a micro short circuit eliminating charge mode, according to the micro short circuit eliminating mode map selected in step S110. Then, the ECU 20 performs control to charge for eliminating the micro short circuit, and terminates the processing (END).

In the micro short circuit eliminating charge mode, the ECU executes a method of eliminating a micro short circuit by charging the lithium-ion battery continuously to maintain the SOC (state of charge), which is the remaining capacity of the lithium-ion battery, at a predetermined value for not shorter than a predetermined time. That is, the micro short circuit eliminating charge mode is a mode of, when performing plug-in charging of the battery 40 of the vehicle 1, continuing to charge until the elapse of a predetermined time after the lithium-ion battery is fully charged. In a PHEV and an HEV, the micro short circuit eliminating charge mode is an operation mode of continuing to regenerate even after regenerating to a predetermined voltage.

Specifically, the ECU performs an SOC maintaining step of charging the lithium-ion battery continuously to maintain the SOC of the lithium-ion battery at a 30% value, for example, for not shorter than a predetermined time, such as not shorter than 30000 seconds indicated by a bullet in FIG. 10. More specifically, first, the dendrite D gradually precipitates from time 0 seconds (bullet on the left in FIG. 11), and a micro short circuit is generated after about 1800 seconds (corner part on the right of right bullet in FIG. 11) in FIG. 11. The charging for eliminating the micro short circuit is started at this point. First, CC charging in which charging is performed at a constant current value is performed for about the first 2500 seconds until the voltage value rises to 3.6V. Then, when the voltage value reaches 3.6V, the operation is switched to CV charging and the CV charging is continued for not shorter than 30000 seconds. Accordingly, while the CV charging is continued, the low SOC area 404, which is formed by the dendrite D generated by precipitated copper as a foreign metal other than a cathode active material mixture or an anode active material mixture and extending between the cathode and the anode in such a manner as to straddle the anode and the cathode, shrinks into the small low SOC area 405 as illustrated in FIG. 3. Then, further continuance of the CV charging homogenizes the low SOC area, so that it reaches a dissolution potential and starts to melt. Hence, the area changes into the state illustrated in FIG. 4, and the micro short circuit is eventually eliminated. The predetermined value of SOC maintained during CC charging and CV charging is a high SOC value, which is maintained by supplying a current higher than the micro short circuit current.

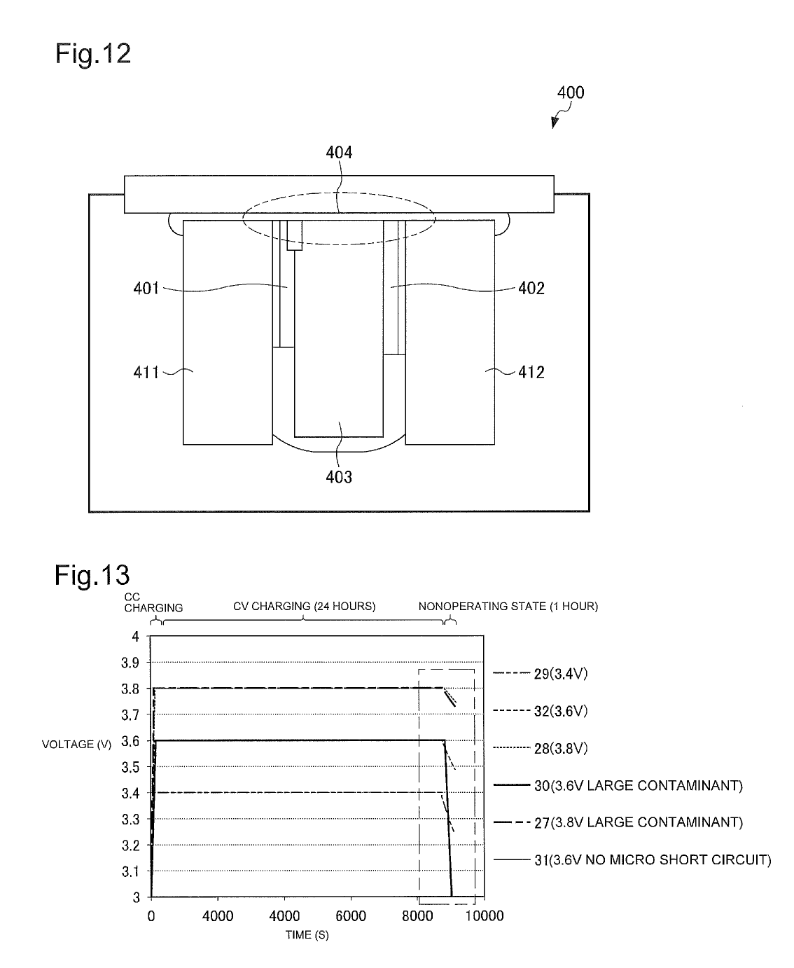

The aforementioned method of eliminating a micro short circuit, lithium-ion battery management method, and charge control method of the vehicle 1 were technically confirmed by the following experiment. As illustrated in FIG. 12, in the experiment, a cathode jig 411 was brought into contact with the cathode 401 of the lithium-ion battery, and an anode jig 412 was brought into contact with the anode 402. FIG. 12 is a schematic diagram of an experiment device for creating a micro short circuit amount-judging map at high temperature of the lithium-ion battery, and a micro short circuit eliminating mode map, used in the vehicle charge control method of the first embodiment of the present invention.

### [Relationship Between Size of Contaminant (Dendrite) and Size of CV Charge Voltage Value]

In an experiment of examining the relationship between the size of a contaminant (not-so-large contaminant and large contaminant) and the size of the CV charge voltage value, multiple different CV charge voltage values were set, and CV charging was performed for 24 hours (about 90000 seconds). Variation in the current value was observed for the not-so-large contaminant and the large contaminant. The experiment results were as illustrated in FIGS. 13 to 18.

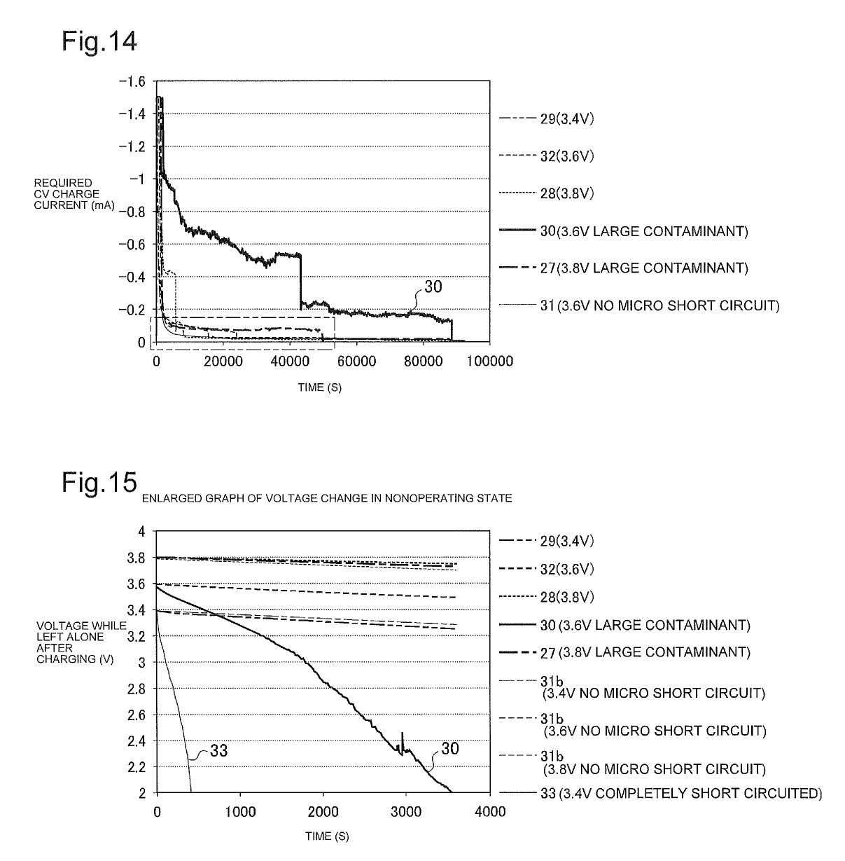

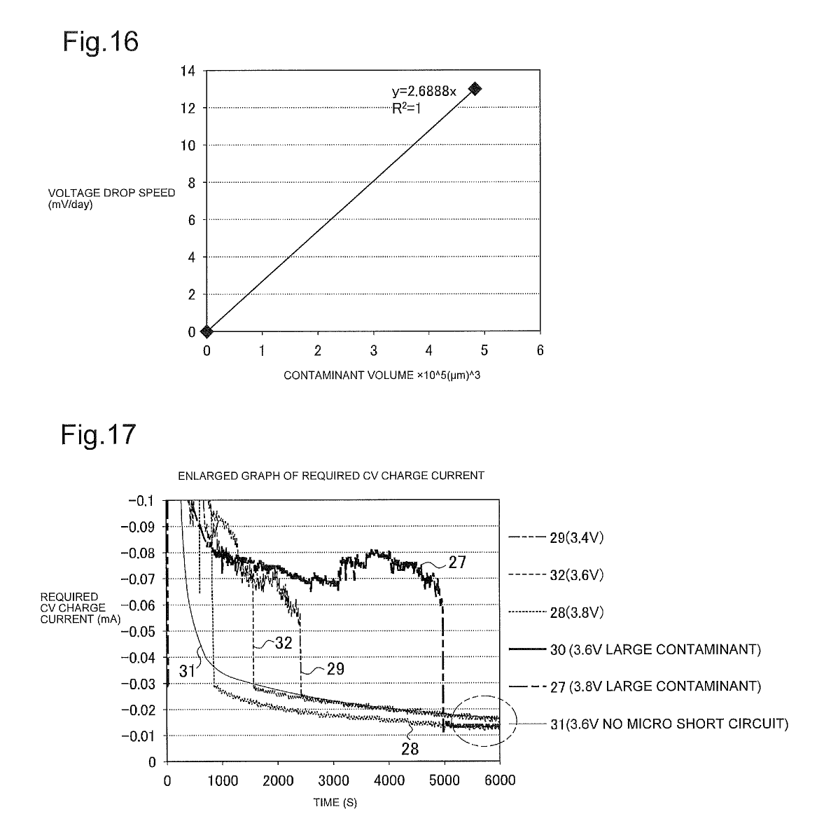

FIG. 13 is a graph illustrating variation in the voltage value over time, when performing CC charging and CV charging to eliminate a micro short circuit by using different voltages for CV charging. FIG. 14 is a graph illustrating variation in the required CV charge current over time, when performing CC charging and CV charging to eliminate a micro short circuit by using different voltages for CV charging. FIG. 15 is a graph illustrating variation in the cell voltage value of lithium-ion battery over time, after performing CC charging and CV charging to eliminate a micro short circuit by using different voltages for CV charging. FIG. 16 is a graph illustrating the relationship between the drop speed of the cell voltage value of lithium-ion battery over time after performing CC charging and CV charging to eliminate a micro short circuit, and the volume of a contaminant forming a dendrite precipitated in the cell.

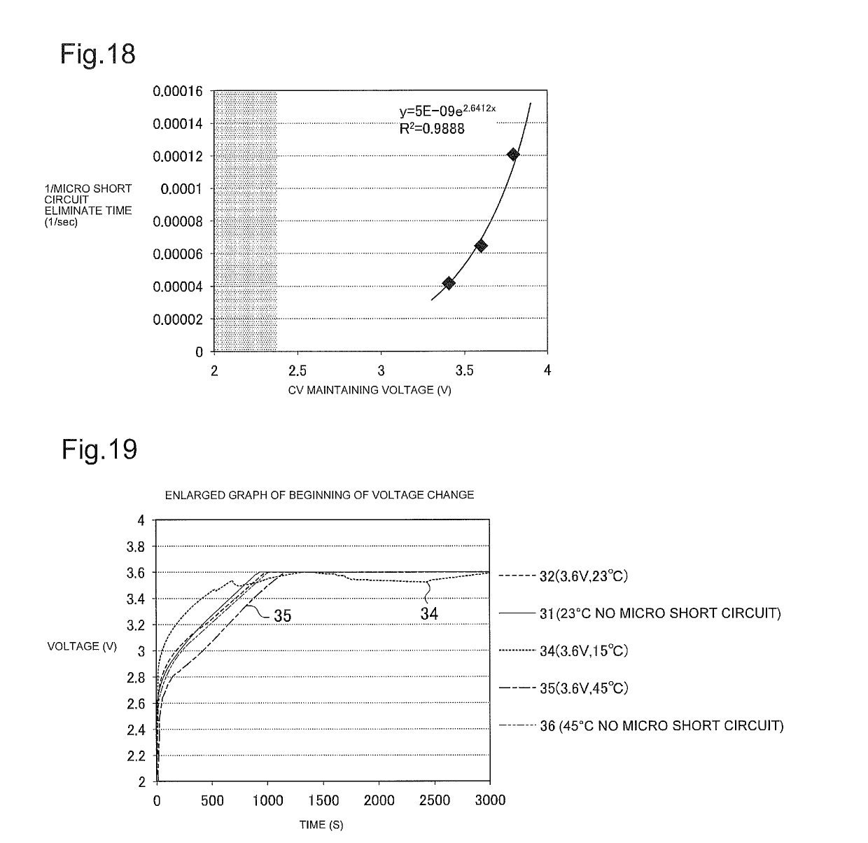

FIG. 17 is a graph illustrating variation in the required CV charge current over time, when performing CV charging to eliminate a micro short circuit by using different voltages for the CV charging. FIG. 18 is a graph illustrating the relationship between the voltage value of CV charging for eliminating a micro short circuit, and the inverse of the required time of eliminating a micro short circuit.

As can be seen from FIG. 17, which is an enlarged view of a part surrounded by a dotted line in a left end part of FIG. 14, the required CV charge current in all of cases where the values of CV charge voltage are 3.4V, 3.6V, and 3.8V, except for when the CV charge voltage value is 3.6V and the contaminant is large (graph indicated by thin solid line and reference numeral “30”), converges to almost the same value as the charge current value (graph indicated by thin solid line and reference numeral “31”) when the CV charge voltage value is 3.6V and no micro short circuit is generated, within 5000 seconds after start of the charging. Accordingly, the micro short circuit appears to be eliminated in these converged cases.

According to the result of the time and CV charge voltage values in FIG. 17, a relationship between a voltage at which CV charging is kept constant and the inverse of the required time of eliminating a micro short circuit is obtained.

According to FIG. 15, which is an enlarged view of a part surrounded by a dotted line in a right end part of FIG. 13, when the CV charge voltage value is set to a relatively high value (3.8V), the voltage while discharging (while not charging) hardly lowers from 3.8V. This indicates that the micro short circuit is eliminated. When the CV charge voltage value is set to 3.6V, if the contaminant is not large, the voltage while discharging hardly lowers from 3.6V. This indicates that the micro short circuit is eliminated. Meanwhile, when the CV charge voltage value is set to 3.6V and the contaminant is large (graph indicated by thick solid line and reference numeral “30”), the voltage while discharging drops rapidly. This indicates that the micro short circuit is not eliminated. For comparison, a short circuited case is indicated by a solid line (solid line indicated by reference numeral “31”) on the lower left, where the CV charge voltage value is set to 3.4V, and the voltage drops rapidly after charging.

According to the result in FIG. 15 of the voltage drop while the lithium-ion battery is left alone after charging, a relationship between the volume of the contaminant and the voltage drop speed in FIG. 16 is obtained. As illustrated in FIG. 16, the volume of the contaminant and the voltage drop speed are proportional.

### [Variation in CV Charge Voltage Value Depending on Temperature]

In an experiment of examining variation in the CV charge voltage value depending on the temperature, the CV charge voltage value was set to 3.6V, CC charging was performed for about 1000 seconds after start of the charging, and then CV charging was performed for about 60000 seconds. Variation in the voltage value and variation in the required CV charge current were observed. The experiment results were as illustrated in FIGS. 19 to 21.

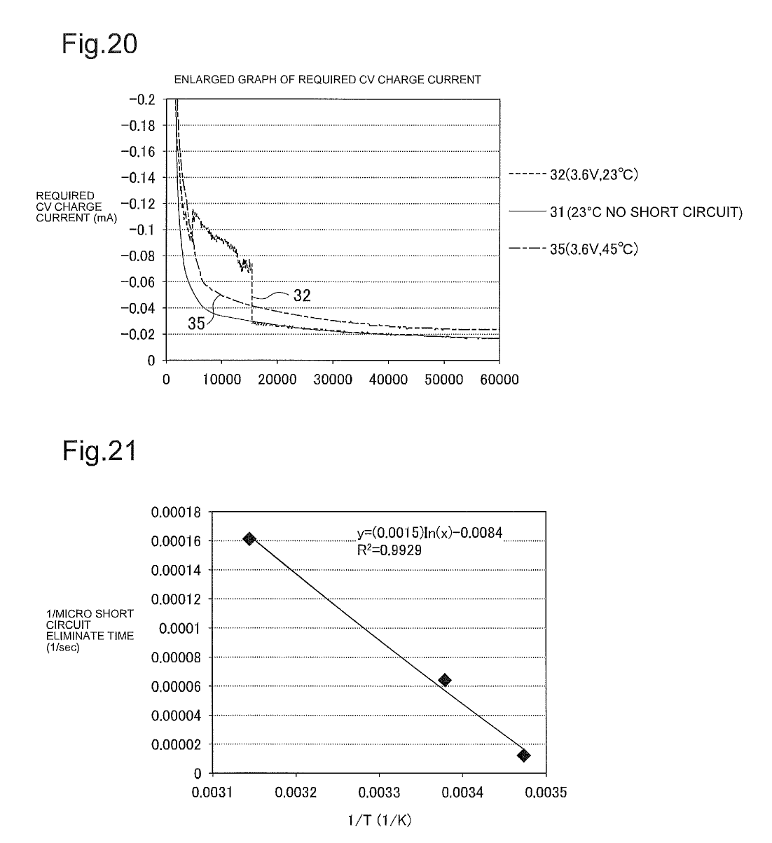

FIG. 19 is a graph illustrating variation in the charge voltage value over time, when performing CC charging and CV charging to eliminate a micro short circuit in lithium-ion batteries of different temperatures. FIG. 20 is a graph illustrating variation in the required CV charge current over time, when performing CC charging and CV charging to eliminate a micro short circuit in lithium-ion batteries of different temperatures. FIG. 21 is a graph illustrating the relationship between the inverse of the temperature of the lithium-ion battery when performing CV charging to eliminate a micro short circuit, and the inverse of the required time of eliminating a micro short circuit.

As can be seen from FIG. 19, at a low temperature (15° C. (graph indicated by thin solid line and reference numeral “34”)), the 3.6V CV voltage value cannot be maintained stably. At other temperatures such as 23° C. and 45° C., the CV voltage value is reached after about 1000 seconds from the start of the CC charging. At the temperature of 45° C., it takes longer to reach the 3.6V value than at the temperature of 23° C. This indicates that electric power is used to eliminate the micro short circuit (melt dendrite D) in the CC charging before the CV charging.

As can be seen from FIG. 20, at the temperature of 45° C., the voltage variation curve is similar to that that when there is no micro short circuit (graph indicated by thin solid line). This indicates that the micro short circuit is already eliminated in CC charging before CV charging. At the temperature of 23° C. (graph indicated by thin solid line and reference numeral “32”), the required CV charge current value is high for about 15000 seconds after start of the charging, indicating that the micro short circuit is not eliminated. However, after about 15000 seconds from start of the charging, the voltage variation curve coincides with that when there is no micro short circuit (graph indicated by thin solid line and reference numeral “31”), indicating that the micro short circuit is eliminated

According to the result of the required CV charge current in FIG. 20, a relationship between the inverse of the temperature of the lithium-ion battery and the inverse of the required time of eliminating a micro short circuit is obtained. As illustrated in FIG. 21, the inverse of the temperature of the lithium-ion battery and the inverse of the required time of eliminating a micro short circuit are proportional.

### [Voltage Change in Nonoperating State Depending on Temperature]

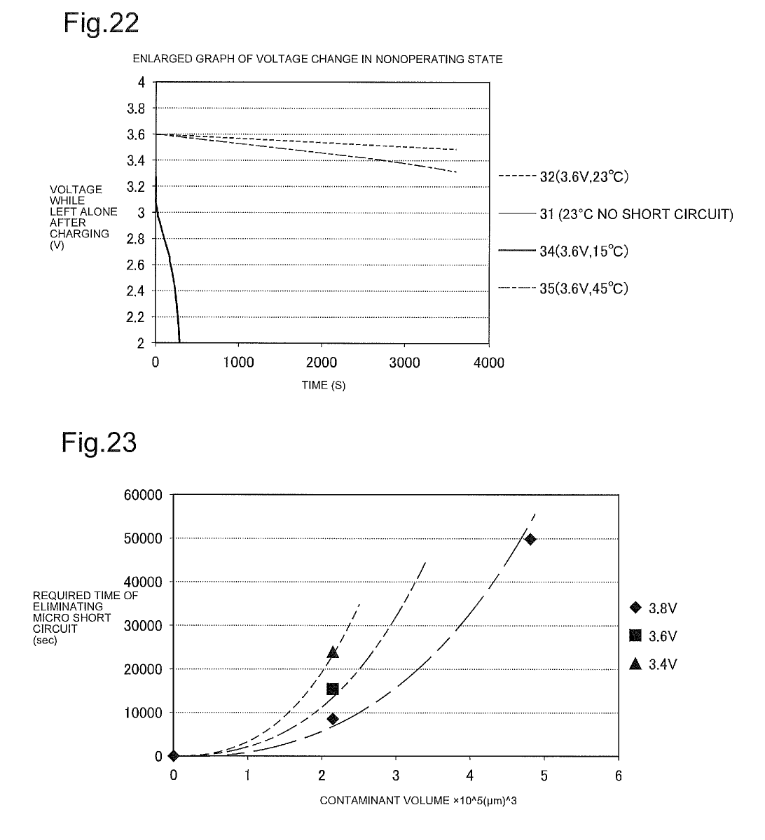

In an experiment of voltage change in a nonoperating state depending on the temperature, changes in the cell voltage under conditions of different temperatures in a nonoperating state, that is, while the lithium-ion battery is left alone after charging, was observed. The experiment results were as illustrated in FIG. 22.

FIG. 22 is a graph illustrating variation in the cell voltage value of lithium-ion battery over time, after performing CC charging and CV charging to eliminate a micro short circuit in lithium-ion batteries of different temperatures.

As can be seen from FIG. 22, the decrease of the voltage is extremely gentle at temperatures 23° C. and 45° C., indicating that the micro short circuit is eliminated. The voltage values differ slightly in these two cases, because of self-discharge depending on the temperature. For comparison, a low-temperature case (15° C.) is indicated by a solid line on the lower left of FIG. 22. In this case, the voltage drops rapidly, indicating that the micro short circuit is not eliminated.

According to the experiment results described above, when different CV charge voltage values are set as in FIG. 23 under condition that the temperature of the lithium-ion battery is 23° C., a relationship between the volume of a contaminant (dendrite D) and how the required time of eliminating a micro short circuit changes, is obtained. FIG. 23 is a graph illustrating the relationship between the required time of eliminating a micro short circuit and the volume of a contaminant forming dendrites precipitated in a cell, when performing CV charging at different voltages.

As illustrated in FIG. 23, the higher the CV charge voltage value, the shorter the required time of eliminating a micro short circuit, and a larger contaminant can be melted to eliminate the micro short circuit.

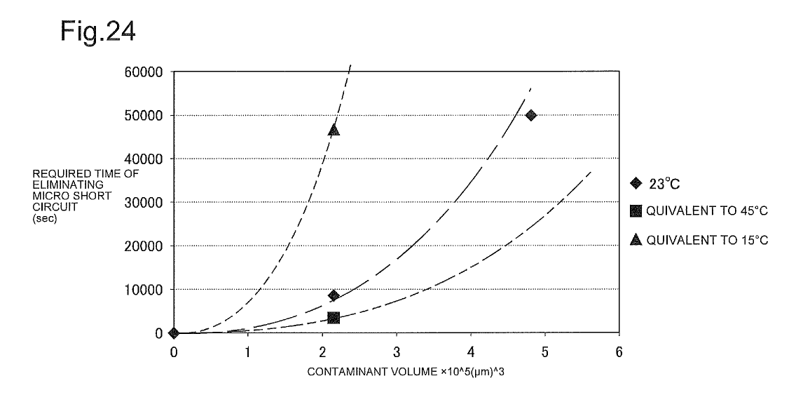

According to the experiment results described above, when the temperature of the lithium-ion battery is varied as in FIG. 24 under condition that the CV charge voltage value is 3.8V, a relationship between the volume of a contaminant and how the required time of eliminating a micro short circuit changes, is obtained. FIG. 24 is a graph illustrating the relationship between the required time of eliminating a micro short circuit and the volume of a contaminant forming dendrites precipitated in a cell, when performing CV charging in lithium-ion batteries of different temperatures.

As illustrated in FIG. 24, the higher the temperature of the lithium-ion battery, the shorter the required time of eliminating a micro short circuit, and a larger contaminant (dendrite D) can be melted to eliminate the micro short circuit.

According to the embodiment, the following effects can be achieved.

The method of eliminating a micro short circuit of the embodiment is a method of eliminating a micro short circuit caused by a dendrite D, which is generated from dissolution and precipitation of a foreign metal other than a cathode active material mixture or an anode active material mixture between a cathode and an anode, of a lithium-ion battery configured of the cathode, the anode, a separator interposed therebetween, and an electrolyte solution filling the lithium-ion battery. The method includes an SOC maintaining step of charging the lithium-ion battery continuously to maintain the SOC of the lithium-ion battery at a predetermined value for not shorter than a predetermined time.

This melts the dendrite D generated by precipitation of the foreign metal other than a cathode active material mixture or an anode active material mixture, and can eliminate the micro short circuit. Hence, instead of handling a lithium-ion battery including a micro short circuit as a defective unit as before, the battery can be used by eliminating the micro short circuit.

The predetermined value is a high SOC value maintained by supplying a higher current than a micro short circuit current. With this, an SOC in which the generated dendrite D loses electrons and melt can be maintained, so that the potential of the generated dendrite can be raised to a dissolution potential.

In the SOC maintaining step, a shorter charge continuing time is set for a higher charge voltage, a longer charge continuing time is set for a lower charge voltage, a shorter charge continuing time is set for a higher lithium-ion battery temperature, and a longer charge continuing time is set for a lower lithium-ion battery temperature. This can eliminate a micro short circuit efficiently.

In the SOC maintaining step, a higher charge voltage is set or a longer charge continuing time is set for a larger micro short circuit amount, and a lower charge voltage is set or a shorter charge continuing time is set for a smaller micro short circuit amount. With this, sufficient voltage and current can be applied depending on the micro short circuit amount, whereby the micro short circuit can be eliminated efficiently.

In the embodiment, the method of managing a lithium-ion battery configured of multiple stacked cells each including a cathode, an anode, a separator interposed therebetween, and an electrolyte solution filling the cell includes: a highly charged state-calculation and measurement step of measuring the voltage of each cell in a highly charged state, and calculating deviation in the voltages of the cells; a less charged state-calculation and measurement step of measuring the voltage of each cell in a less charged state after the elapse of a predetermined time from the highly charged state-calculation and measurement step, and calculating deviation in the voltages of the cells; a micro short circuit generation judging step of judging generation of a micro short circuit, by comparing deviations in cell voltages in the highly charged state and in the less charged state; and a step of executing a micro short circuit eliminating operation upon generation of a micro short circuit.

With this, it is possible to detect generation of a micro short circuit in a certain cell of the lithium-ion battery, and start a micro short circuit eliminating operation of eliminating the micro short circuit in the cell where the micro short circuit has generated.

The micro short circuit eliminating operation includes an operation of charging the lithium-ion battery continuously to maintain the SOC of the lithium-ion battery at a predetermined value for not shorter than a predetermined time.

This melts the dendrite D generated by precipitation of the foreign metal other than a cathode active material mixture or an anode active material mixture, and can eliminate the micro short circuit.

In the embodiment, the charge control method of the vehicle equipped with a lithium-ion battery configured of multiple stacked cells each including a cathode, an anode, a separator interposed therebetween, and an electrolyte solution filling the cell includes: a step of measuring the voltage of each cell at the time of stopping of the vehicle after running, and calculating deviation in the voltages of the cells; a step of measuring the voltage of each cell at the time of starting of the vehicle, and calculating deviation in the voltages of the cells; a step of judging generation of a micro short circuit by comparing deviations in cell voltages at times of starting and stopping of the vehicle; and a step of transitioning to a micro short circuit eliminating charge mode upon generation of a micro short circuit.

With this, it is possible to detect generation of a micro short circuit in a certain cell of the lithium-ion battery of the vehicle 1 such as an electric vehicle (EV), and transition to a micro short circuit eliminating charge mode of eliminating the micro short circuit in the cell where the micro short circuit has generated. Hence, instead of detaching the lithium-ion battery including the micro short circuit from the vehicle 1 and replacing it, the micro short circuit can be eliminated to use the lithium-ion battery as a battery that does not include a micro short circuit.

The micro short circuit eliminating charge mode is a mode in which the lithium-ion battery is charged continuously to maintain the SOC of the lithium-ion battery at a predetermined value for not shorter than a predetermined time. This melts the dendrite D generated by precipitation of the foreign metal other than a cathode active material mixture or an anode active material mixture, and can eliminate the micro short circuit.

The micro short circuit eliminating charge mode is a mode in which, when performing plug-in charging, charging is continued until the elapse of a predetermined time after the lithium-ion battery is fully charged. Hence, at the time of plug-in charging after generation of a micro short circuit, the micro short circuit can be eliminated after the lithium-ion battery is fully charged. In a PHEV and an HEV, the micro short circuit eliminating charge mode is an operation mode of continuing to regenerate even after regenerating to a predetermined voltage.

### Second Embodiment

A vehicle 1 of a second embodiment of the present invention is different from the vehicle 1 of the first embodiment in that it includes an unillustrated solar cell, and that the micro short circuit eliminating charge mode is a mode in which charging is performed with the unillustrated solar cell installed in the vehicle 1. Other configurations are the same as the vehicle 1 of the first embodiment.

According to this configuration, since the required electric power to eliminate a micro short circuit is extremely small, a micro short circuit can be eliminated easily by use of the solar cell.

### Third Embodiment

A vehicle 1 of a third embodiment of the present invention is different from the vehicle 1 of the first embodiment in that the micro short circuit eliminating charge mode is a mode in which the charge voltage of the running vehicle 1 is increased to a high voltage. Other configurations are the same as the vehicle 1 of the first embodiment.

According to this configuration, even when generation of a micro short circuit is detected while the vehicle 1 is running, the micro short circuit can be eliminated easily while the vehicle 1 is running.

For example, although the method of eliminating a micro short circuit and the lithium-ion battery management method are implemented in the vehicle 1, the methods are not limited to the vehicle 1. Instead, the methods may be implemented in other products equipped with a lithium-ion battery.

For example, numeric values of the CV charge voltage value, temperature of the lithium-ion battery, and the like are not limited to the numeric values of the CV charge voltage value, temperature of the lithium-ion battery, and the like of the embodiments.

Although the micro short circuit is eliminated by plug-in charging, solar cell, and charging while running in the embodiments, the way of eliminating a micro short circuit is not limited to these.

Although the vehicle 1 of the above embodiments is an electric vehicle (EV) that uses the electric motor 10 as a power source, the invention is not limited to this. For example, the vehicle may be a vehicle that uses the electric motor 10 as a power source such as a hybrid electric vehicle (HEV), a plug-in hybrid electric vehicle (PHEV), a fuel cell electric vehicle, and a plug-in fuel cell electric vehicle (PFCV).

Obviously, numerous modifications and variations of the present invention are possible in light of the above teachings. It is therefore to be understood that within the scope of the appended claims, the invention may be practiced otherwise than as specifically described herein.

What is claimed is:

1. A method of eliminating a micro short circuit caused by a dendrite, which is generated from dissolution and precipitation of a foreign metal other than a cathode active material mixture or an anode active material mixture between a cathode and an anode, of a lithium-ion battery configured of said cathode, said anode, a separator interposed therebetween, and an electrolyte solution filling the lithium-ion battery, the method comprising
an SOC maintaining step of charging said lithium-ion battery continuously to maintain an SOC of said lithium-ion battery at a predetermined value for not shorter than a predetermined time.

2. The method according to claim 1, wherein
said predetermined value is a high SOC value maintained by supplying a higher current than a micro short circuit current.

3. The method according to claim 1, wherein
said predetermined value is a value that can maintain an SOC in which a metal contaminant loses electrons and reaches a dissolution potential.

4. The method according to claim 1, wherein
in the SOC maintaining step, a shorter charge continuing time is set for a higher charge voltage, a longer charge continuing time is set for a lower charge voltage, a shorter charge continuing time is set for a higher temperature of said lithium-ion battery, and a longer charge continuing time is set for a lower temperature of said lithium-ion battery.

5. The method according to claim 1, wherein
in the SOC maintaining step, a higher charge voltage is set or a longer charge continuing time is set for a larger micro short circuit amount, and a lower charge voltage is set or a shorter charge continuing time is set for a smaller micro short circuit amount.

6. A method for decreasing a dendrite generated in a lithium-ion battery, the method comprising:
charging the lithium-ion battery so that the dendrite is generated due to precipitation of a foreign metal other than a cathode active material mixture and an anode active material mixture in an electrolyte solution filling the lithium-ion battery; and
charging the lithium-ion battery to maintain an SOC of the lithium-ion battery at a predetermined value for more than a predetermined time to decrease the dendrite.

7. The method according to claim 6, wherein
the predetermined value is a high SOC value maintained by supplying a higher current than a micro short circuit current flowing the dendrite.

8. The method according to claim 6, wherein
the predetermined value is a value to maintain an SOC in which a metal contaminant loses electrons and reaches a dissolution potential.

9. The method according to claim 6, wherein
a shorter charge continuing time is set for a higher charge voltage, a longer charge continuing time is set for a lower charge voltage, a shorter charge continuing time is set for a higher temperature of the lithium-ion battery, and a longer charge continuing time is set for a lower temperature of the lithium-ion battery.

10. The method according to claim 6, wherein
to decrease the dendrite, a higher charge voltage is set or a longer charge continuing time is set for a larger micro short circuit amount, and a lower charge voltage is set or a shorter charge continuing time is set for a smaller micro short circuit amount.

11. A charge control device for a lithium-ion battery, comprising:
a power drive circuit to charge the lithium-ion battery;
a processor configured to control the power drive circuit to:
charge the lithium-ion battery so that a dendrite is generated due to precipitation of a foreign metal other than a cathode active material mixture and an anode active material mixture in an electrolyte solution filling the lithium-ion battery; and
charge the lithium-ion battery to maintain an SOC of the lithium-ion battery at a predetermined value for more than a predetermined time to decrease the dendrite.

12. A charge control device for a lithium-ion battery, comprising:
a power drive circuit for charging the lithium-ion battery;
control means for controlling the power drive circuit to:
charge the lithium-ion battery so that a dendrite is generated due to precipitation of a foreign metal other than a cathode active material mixture and an anode active material mixture in an electrolyte solution filling the lithium-ion battery; and
charge the lithium-ion battery to maintain an SOC of the lithium-ion battery at a predetermined value for more than a predetermined time to decrease the dendrite.
